(19) United States
(12) Patent Application Publication
(10) Pub. No.: US 2025/0380673 A1
(43) Pub. Date: Dec. 18, 2025

(54) SYSTEM AND METHOD FOR FERTILITY EVALUATION IN ANIMALS

(71) Applicant: S.C.R. (ENGINEERS) LIMITED, Netanya (IL)

(72) Inventors: Guy FRIDKOVSKI, Netanya (IL); Kenneth WRONKA, Santa Clara, CA (US); Luís Gustavo DELAMANHA MENDONÇA, Rahway, NJ (US); Todd BILBY, Rahway, NJ (US)

(21) Appl. No.: 18/741,859

(22) Filed: Jun. 13, 2024

(51) Int. Cl. A01K 29/00

(52) U.S. Cl. CPC A01K 29/005

(57) ABSTRACT

The presently disclosed subject matter relates to a system and method for evaluating a level of fertility of a given animal. The system and method include a processing circuitry configured to: obtain: (i) information relating to estrus events occurring in said given animal during a first period following a calving event, and (ii) information relating to rumination behavior exhibited by said animal during a second period following said calving event; and, based on said information relating to estrus events and said information relating to rumination behavior, evaluate the level of fertility of said given animal.

### TECHNICAL FIELD

The present invention relates to the field of fertility evaluation in animals, and more particularly in livestock.

### BACKGROUND

In the animal farming industry, reproductive efficiency is measured by the ability of a given animal to achieve pregnancy. An animal that is able to efficiently reproduce is a key driver of profit in animal farming as it allows farmers to quickly breed said animal after calving with a minimum number of inseminations. As an added potential benefit is to breed high-efficiency animals at a later time to prolong their milking period before dry-off. Ultimately, the challenge is to achieve pregnancies in a timely and cost-effective manner, as both aspects affect profitability.

Unfortunately, reproductive efficiency has been adversely affected by declining fertility in recent decades. This is evidenced by a decrease in estrus detection rates, an increase in the number of services per conception, and a decline in conception rates. Variations in conception rates have been linked to several factors, such as age, body condition, energy balance, milk yield, health status, days post-calving, heat stress, and lameness. Reproductive hormones, such as Fertagyl (gonadorelin acetate), cloprostenol (Estrumate), and Chorulon (human chorionic gonadotropin), can be used to treat reproductive disorders in order to restore reproductive efficiency. In addition, Fertagyl and Estrumate can be used for estrous cycle synchronization to allow for fixed time artificial insemination with the goal to improve reproductive performance. In general, reproductive hormones such as these can be used to induce estrus at an earlier time by treating certain reproductive conditions and/or to synchronize the estrous cycle to allow insemination in a timely manner. As one example, reproductive hormones may be administered to an animal 30 to 50 days after calving to help ensure first insemination occurs rapidly.

Despite significant efforts to investigate factors associated with conception rates, only a few studies have attempted to predict the outcome of an individual insemination event (i.e., pregnant or not pregnant). Knowing when an animal is likely to conceive, once inseminated, would enable farmers to make the most informed breeding decisions.

Thus, there is a need in the art for new systems and methods for fertility evaluation in animals.

### GENERAL DESCRIPTION

In accordance with a first aspect of the presently disclosed subject matter, there is provided a system for evaluating a level of fertility of a given animal, the system comprising a processing circuitry configured to: obtain: (i) information relating to estrus events occurring in the given animal during a first period following a calving event, and (ii) information relating to rumination behavior exhibited by the animal during a second period following the calving event; and, based on the information relating to estrus events and the information relating to rumination behavior, evaluate the level of fertility of the given animal.

In one embodiment of the presently disclosed subject matter and/or embodiments thereof, the first period extends between day 1 and day 50, post calving.

In one embodiment of the presently disclosed subject matter and/or embodiments thereof, the first period extends between day 25 and day 50, post calving.

In one embodiment of the presently disclosed subject matter and/or embodiments thereof, the duration of the first period varies depending on the given animal's number of lactations and the intensity of estrus.

In one embodiment of the presently disclosed subject matter and/or embodiments thereof, the second period extends between day 1 and day 15, post calving.

In one embodiment of the presently disclosed subject matter and/or embodiments thereof, the second period extends between day 1 and day 4, post calving.

In one embodiment of the presently disclosed subject matter and/or embodiments thereof, the given animal is a livestock animal.

In one embodiment of the presently disclosed subject matter and/or embodiments thereof, the livestock animal is one of: a cow, a sow, a mare, an ewe, or a doe.

In one embodiment of the presently disclosed subject matter and/or embodiments thereof, the level of fertility is represented by one of three levels: high level of fertility, medium level of fertility, and low level of fertility.

In one embodiment of the presently disclosed subject matter and/or embodiments thereof, the level of fertility is represented by a fertility percentage, ranging between 0 and 100%.

In one embodiment of the presently disclosed subject matter and/or embodiments thereof, the information relating to rumination behavior involves one or more of the following: (i) rumination activity per day, (ii) rumination activity ratio, and (iii) rumination peak.

In one embodiment of the presently disclosed subject matter and/or embodiments thereof, the information relating to estrus events may include one or more of: (i) a number of estrus events occurring in the given animal during the first period, and (ii) a level of intensity of one or more of the estrus events.

In one embodiment of the presently disclosed subject matter and/or embodiments thereof, based on the evaluation of the level of fertility, the system provides one or more suggestions on how to improve the animal's fertility.

In one embodiment of the presently disclosed subject matter and/or embodiments thereof, the suggestions involve providing a customized program of treatment based on the animal's properties. In certain embodiments, such suggested customized program(s) of treatment could be further reviewed by a veterinary professional. For example, such suggestions could be provided to a veterinary professional for review and implementation

In one embodiment of the presently disclosed subject matter and/or embodiments thereof, the animal's properties are one or more of: age, body condition, energy balance, and fertility level.

In one embodiment of the presently disclosed subject matter and/or embodiments thereof, the system is configured to also obtain activity-related information exhibited by the animal following the calving event and evaluate the level of fertility of the animal based on the activity-related information along with the information relating to estrus events and the information relating to rumination behavior.

In one embodiment of the presently disclosed subject matter and/or embodiments thereof, the activity-related information includes one or more of: daily activity, and daily activity ratio.

In accordance with a second aspect of the presently disclosed subject matter, there is provided a method for evaluating a level of fertility of a given animal comprising: obtaining: (i) information relating to estrus events occurring in the given animal during a first period following a calving event, and (ii) information relating to rumination behavior exhibited by the animal during a second period following the calving event; and, based on the information relating to estrus events and the information relating to rumination behavior, evaluating the level of fertility of the given animal.

In one embodiment of the presently disclosed subject matter and/or embodiments thereof, the first period extends between day 1 and day 50, post calving.

In one embodiment of the presently disclosed subject matter and/or embodiments thereof, the first period extends between day 25 and day 50, post calving.

In one embodiment of the presently disclosed subject matter and/or embodiments thereof, the duration of the first period varies depending on the given animal's number of lactations and the intensity of estrus.

In one embodiment of the presently disclosed subject matter and/or embodiments thereof, the second period extends between day 1 and day 15, post calving.

In one embodiment of the presently disclosed subject matter and/or embodiments thereof, the second period extends between day 1 and day 4, post calving.

In one embodiment of the presently disclosed subject matter and/or embodiments thereof, the given animal is a livestock animal.

In one embodiment of the presently disclosed subject matter and/or embodiments thereof, the livestock animal is one of: a cow, a sow, a mare, an ewe, or a doe.

In one embodiment of the presently disclosed subject matter and/or embodiments thereof, the level of fertility is represented by one of three levels: high level of fertility, medium level of fertility, and low level of fertility.

In one embodiment of the presently disclosed subject matter and/or embodiments thereof, the level of fertility is represented by a fertility percentage, ranging between 0 and 100%.

In one embodiment of the presently disclosed subject matter and/or embodiments thereof, the information relating to rumination behavior involves one or more of the following: (i) rumination activity per day, (ii) rumination activity ratio, and (iii) rumination peak.

In one embodiment of the presently disclosed subject matter and/or embodiments thereof, the information relating to estrus events may include one or more of: (i) a number of estrus events occurring in the given animal during the first period, and (ii) a level of intensity of one or more of the estrus events.

In one embodiment of the presently disclosed subject matter and/or embodiments thereof, based on the evaluation of the level of fertility, the system provides one or more suggestions on how to improve the animal's fertility.

In one embodiment of the presently disclosed subject matter and/or embodiments thereof, the suggestions involve providing a customized program of treatment based on the animal's properties. In certain embodiments, such customized programs of treatment could be further reviewed by a veterinary professional. For example, the customized programs could be provided to a veterinary professional for review and implementation.

In one embodiment of the presently disclosed subject matter and/or embodiments thereof, the animal's properties are one or more of: age, body condition, energy balance, and fertility level.

In one embodiment of the presently disclosed subject matter and/or embodiments thereof, the obtaining stage includes obtaining activity-related information exhibited by the animal following the calving event and evaluating the level of fertility of the animal based on the activity-related information along with the information relating to estrus events and the information relating to rumination behavior.

In one embodiment of the presently disclosed subject matter and/or embodiments thereof, the activity-related information includes one or more of: daily activity, and daily activity ratio.

In accordance with a third aspect of the presently disclosed subject matter, there is provided a non-transitory computer readable storage medium having computer readable program code embodied therewith, the computer readable program code, executable by at least one processor to perform a method for evaluating a level of fertility of a given animal, the method for evaluating a level of fertility of a given animal comprising: obtaining: (i) information relating to estrus events occurring in the given animal during a first period following a calving event, and (ii) information relating to rumination behavior exhibited by the animal during a second period following the calving event; and, based on the information relating to estrus events and the information relating to rumination behavior, evaluating the level of fertility of the given animal.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an environment in which the system for fertility evaluation in animals operates, in accordance with the presently disclosed subject matter;

FIG. 2 is a block diagram schematically illustrating one example of a system for fertility evaluation in animals, in accordance with the presently disclosed subject matter;

FIG. 3 is a flowchart illustrating an example of a sequence of operations carried out by a system for fertility evaluation in animals, in accordance with the presently disclosed subject matter;

FIG. 4 is a schematic illustration of an exemplary experiment designed to evaluate the reproductive efficiency of three animal groups, in accordance with the presently disclosed subject matter; and,

FIG. 5 illustrates three graphs, 5A to 5C, demonstrating the correlation between days to pregnancy and the percentage of dairy cows pregnant after calving, according to their lactation number, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “determining”, or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter, fewer, more and/or different stages than those shown in FIG. 3 may be executed. In embodiments of the presently disclosed subject matter one or more stages illustrated in FIG. 3 may be executed in a different order and/or one or more groups of stages may be executed simultaneously. FIG. 2 illustrates a general schematic of the system architecture in accordance with an embodiment of the presently disclosed subject matter. Each module in FIG. 2 can be made up of any combination of software, hardware and/or firmware that performs the functions as defined and explained herein. The modules in FIG. 2 may be centralized in one location or dispersed over more than one location. In other embodiments of the presently disclosed subject matter, the system may comprise fewer, more, and/or different modules than those shown in FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

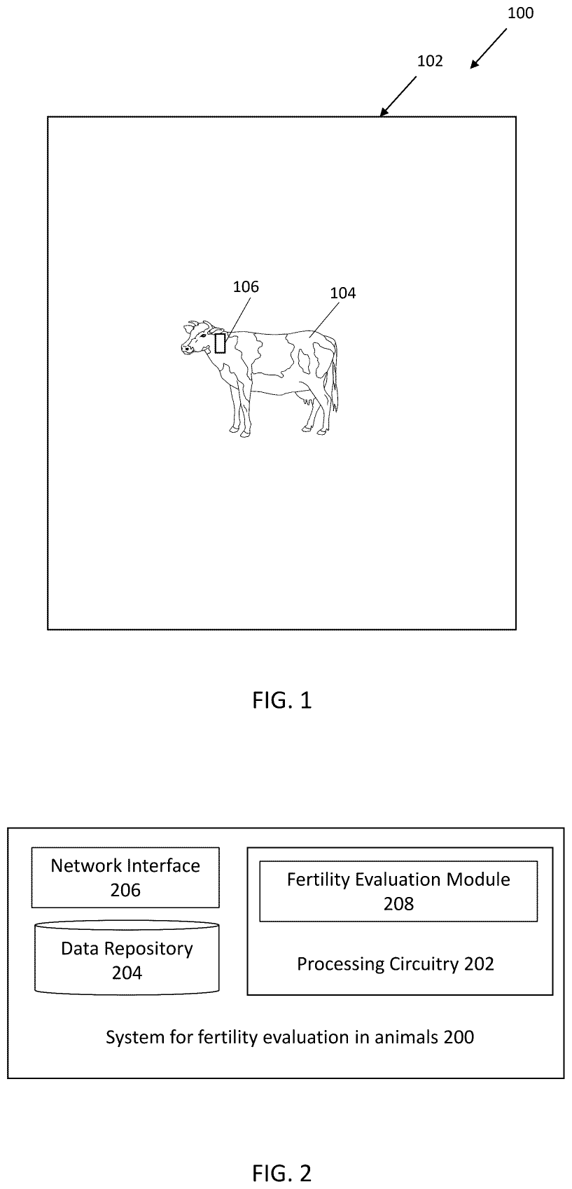

Bearing this in mind, attention is drawn to FIG. 1, showing a schematic illustration of an environment in which the system for fertility evaluation in animals (also interchangeably referred to herein as “system”) operates, in accordance with the presently disclosed subject matter.

As shown in the schematic illustration, environment 100 includes an area (e.g., a controlled area, such as a controlled pen, a controlled barn, and the like, an uncontrolled area, such as a meadow, a field, and the like, or a combination of both), denoted 102, containing one or more animals (e.g., cow(s), sow(s), mare(s), ewe(s), etc.), represented by dairy cow 104.

It is to be of note throughout the description below that whenever a reference to dairy cow 104 is made, said reference may be interpreted as referring to an actual dairy cow, as well as to other animal types.

Dairy cow 104 may be associated with at least one monitoring device (e.g., a tag (ear tags, neck tags, etc.), a collar (neck collars, etc.), an internal implant (e.g., a microchip bolus, implanted device, etc.), and the like), denoted 106, coupled to at least one body part of said dairy cow (e.g., the ear(s), the tail, the leg(s), the neck, etc.).

In some cases, monitoring device 106 may be a combination of devices (e.g. an internal implant and tag; and ear tag and a neck tag; a collar and a tag; etc.).

Monitoring device 106 may contain one or more sensors (e.g., a vibration sensor, a temperature sensor, a velocity sensor, an acceleration sensor (e.g., an accelerometer), a gyroscope, a magnetometer, a pedometer, a location sensor (e.g., a Global Positioning System receiver), a heart rate sensor, a moisture sensor, etc.) configured to collect information relating to said dairy cow. In one example, the collected information may include behavioral information associated with one or more behaviors exhibited by dairy cow 104 (e.g., rumination, grazing, eating, drinking, walking, resting, location, activity, etc.). In another example, alternatively or additionally to the above, the collected information may include physiological information, collected from dairy cow 104's body (e.g., its temperature, heart rate, pH, etc.), related to one or more conditions and/or states of said dairy cow.

It should be of note that the types of information listed above serve as mere examples and that other types of information, alternatively or additionally to the ones listed above, may also be collected by said sensors.

It should also be of note that the collected information may be acquired by other means (e.g., vision system(s), certified professional(s), etc.) capable of operating in conjunction with or instead of monitoring device 106.

During its lifespan, dairy cow 104 may go through one or more breeding seasons, during which said dairy cow may experience one or more events of estrus or heat, indicating the readiness of said dairy cow to accept a male and mate, or alternatively, be artificially inseminated. At the end of each breeding season, dairy cow 104 may or may not become pregnant, depending largely on its level of fertility.

While breeding seasons and events of estrus or heat are well defined and relatively straightforwardly identifiable, as they are closely related to certain behaviors exhibited during which, predicting the outcome of an insemination event (natural or artificial) remains a challenge due to the inability to properly and accurately evaluate an animal's fertility level.

To cope with this, the system for fertility evaluation in animals of the presently disclosed subject matter may perform a fertility evaluation process as described in further detail hereafter with respect to FIG. 3.

Attention is now drawn to the components of the system for fertility evaluation in animals 200.

FIG. 2 is a block diagram schematically illustrating one example of the system for fertility evaluation in animals 200, in accordance with the presently disclosed subject matter.

In accordance with the presently disclosed subject matter, the system for fertility evaluation in animals 200 (also interchangeably referred to herein as “system 200”) can comprise a network interface 206. The network interface 206 (e.g., a network card, a Wi-Fi client, a Li-Fi client, 3G/4G client, or any other communication component) enables system 200 to communicate over a network with external systems and handles inbound and outbound communications from such systems. For example, system 200 can receive information associated with behaviors exhibited by dairy cow 104, through network interface 206.

System 200 can further comprise or be otherwise associated with a data repository 204 (e.g., a database, a storage system, a memory including Read Only Memory—ROM, Random Access Memory—RAM, or any other type of memory, etc.) configured to store data. Some examples of data that can be stored in the data repository 204 include:
Physiological information associated with one or more animals;
Behavioral information associated with one or more animals;
Activity-related information associated with one or more animals;
Number of estrus events associated with one or more animals;
Strength (including relative strength) of estrus events associated with one or more animals;
Levels of fertility of one or more animals;
One or more first periods following one or more calving events associated with one or more animals;
One or more second periods following one or more calving events associated with one or more animals;
Information relating to rumination behavior of one or more animals following one or more calving events; etc.

Data repository 204 can be further configured to enable retrieval and/or update and/or deletion of the stored data. It is to be noted that in some cases, data repository 204 can be distributed, while system 200 has access to the information stored thereon, e.g., via a wired or wireless network to which system 200 is able to connect (utilizing its network interface 206).

System 200 further comprises processing circuitry 202. Processing circuitry 202 can be one or more processing units (e.g., central processing units), microprocessors, microcontrollers (e.g., microcontroller units (MCUs)) or any other computing devices or modules, including multiple and/or parallel and/or distributed processing units, which are adapted to independently or cooperatively process data for controlling relevant system 200 resources and for enabling operations related to system's 200 resources.

The processing circuitry 202 may include a fertility evaluation module 208, configured to perform a fertility evaluation process, as further detailed herein, inter alia, with reference to FIG. 3.

Turning to FIG. 3, there is shown a flowchart illustrating one example of a sequence of operations carried out by the system for fertility evaluation in animals 200, in accordance with the presently disclosed subject matter.

Accordingly, the system for fertility evaluation in animals 200 can be configured to perform a fertility evaluation process 300, e.g., using the fertility evaluation module 208.

For this purpose, the system for fertility evaluation in animals 200 obtains: (i) information relating to estrus events occurring in said given animal during a first period following a calving event, and (ii) information relating to rumination behavior exhibited by said animal during a second period following said calving event (block 302).

In one non-limiting example, the information relating to estrus events may include the number of estrus events occurring in said given animal during said first period. In another non-limiting example, alternatively or additionally to the former, the information relating to estrus events may include the level of intensity of one or more of said estrus events. As another non-limiting example, the information relating to estrus events may include the number of estrus events and the level of intensity of one or more of said estrus events.

It is to be of note that the above examples are presented merely for the purpose of better understanding the presently disclosed subject matter and not intended in any way to limit its scope.

It is to be further of note that in cases where the information relating to estrus events involves a number of estrus events, such number may be impacted by external changes involving said given animal. For example, assuming said animal experiences an estrus event concurrently or shortly after a move to a different group of animals or entry to a herd, said event may be excluded from consideration as it is considered a non-real estrus event.

In some cases, the first period following a calving event may extend between day 1 and day 50 post calving. In other cases, the first period following the calving event may extend between day around 25 and around day 50 post calving. In other cases, this period may be between days 24 and 55. In other cases, the duration of the first period may vary depending on the given animal's number of lactations and/or the intensity of estrus. In cases involving estrus intensity, said intensity may be determined by evaluating a heat index, ranging from 0 (no estrus) to 100 (highest estrus intensity). The heat index may be established, for example, by evaluating an increased activity and decreased rumination of said given animal.

It to be of note that the above cases serve as mere examples not intended in any way to limit the scope of the presently disclosed subject matter.

In some cases, the second period following said calving event may extend between day 1 and day 15, post calving. In other cases, the second period may extend between any other day range, for example, between day 1 and day 4, post calving.

It to be of note that the above cases serve as mere examples not intended in any way to limit the scope of the presently disclosed subject matter.

In some cases, the information relating to rumination behavior exhibited during said second period may involve one or more of the following, alone or in combination: rumination activity per day, rumination activity ratio, rumination peak, etc.

Next, based on the information relating to estrus events and the information relating to rumination behavior, system 200 evaluates the level of fertility of said given animal (block 304).

In some cases, the level of fertility may be represented by several fertility levels, e.g., high level of fertility, medium level of fertility, and low level of fertility. In other cases, the level of fertility may be represented by a fertility percentage, ranging between 0 and 100%.

It to be of note that the above cases serve as mere examples not intended in any way to limit the scope of the presently disclosed subject matter.

In some cases, based on the evaluation of the level of fertility, system 200 may provide suggestions on how to improve the animal's fertility. Such suggestions could be, for example, provided to a veterinary professional for review and implementation. For example, system 200 may provide a customized program of treatment based on the animal's properties (age, body condition, energy balance, fertility level, etc.). In one non-limiting example, a customized program may involve using a different type of semen (e.g., sex-sorted or conventional semen) and/or type of breed (e.g., beef-sired or dairy-sired semen). In another non-limiting example, alternatively or additionally to the former, a customized program may specify when animals are eligible to start the reproductive program following a calving event, and which type of synchronization program to utilize for the inseminations.

In some cases, the fertility level (as determined by the systems and methods described herein) may be used, for example by a veterinary professional, to help determine which reproductive hormones to give to an animal, when they should be given, how often they should be given, and at what dosage. For example, depending on the level of fertility, specific synchronization programs involving Fertagyl (gonadorelin acetate) and Estrumate (cloprostenol) can be used to optimize fertility by either inducing estrus or allowing for fixed time artificial insemination. In addition, the evaluation of reproductive disorders and the level of fertility may be used to determine which reproductive hormone, including, for example, Chorulon (human chorionic gonadotropin), may be indicated for specific animals. The strategy to combine the level of fertility with specific reproductive hormones and synchronization programs may be used in different treatment approaches. In one non-limiting example, animals with medium and low level of fertility may require several reproductive hormones to resolve reproductive disorders or to synchronize the estrous cycle.

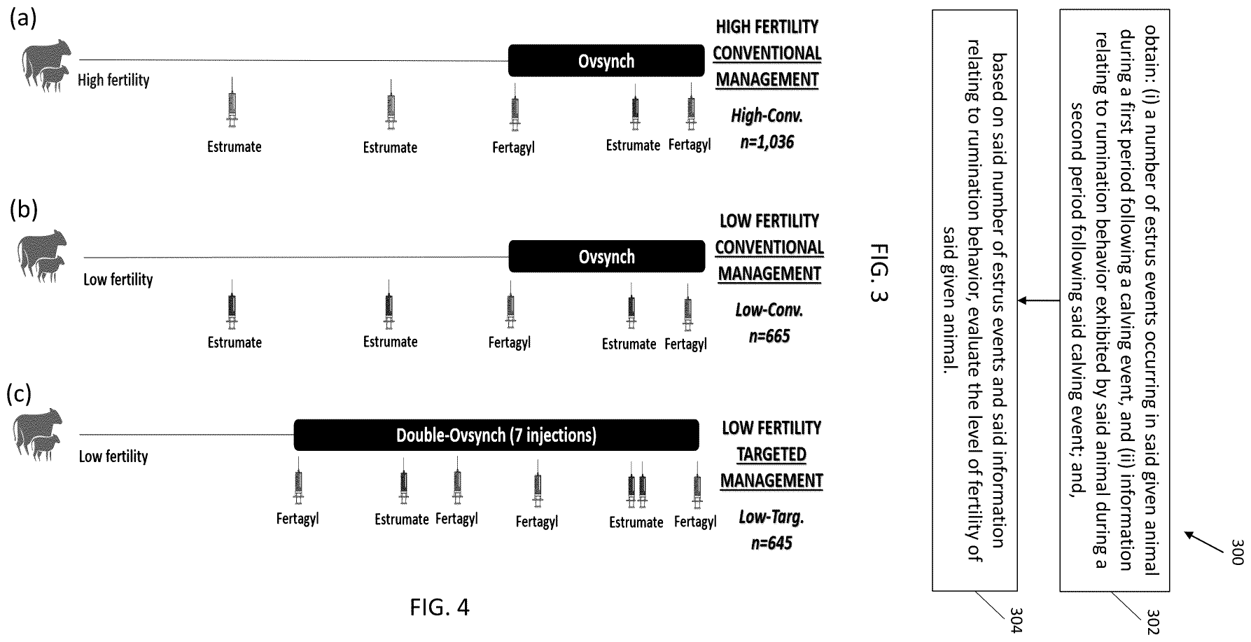

By way of a non-limiting example, in correlation with the above, FIG. 4 illustrates an exemplary experiment designed to evaluate the reproductive efficiency of three animal groups: (a) a group of high fertility dairy cows, the fertility level of which was determined by the systems and methods described herein, submitted to a synchronization program focused on insemination based on estrus detection; (b) a group of low fertility dairy cows, the fertility level of which was determined by the systems and methods described herein, submitted to a synchronization program focused on insemination based on estrus detection; and (c) a group of low fertility dairy cows, the fertility level of which was determined by the systems and methods described herein, submitted to a synchronization program focused on fixed time artificial insemination. For all groups participating in said experiment, Fertagyl and Estrumate were administered to induce estrus or synchronize the estrous cycle.

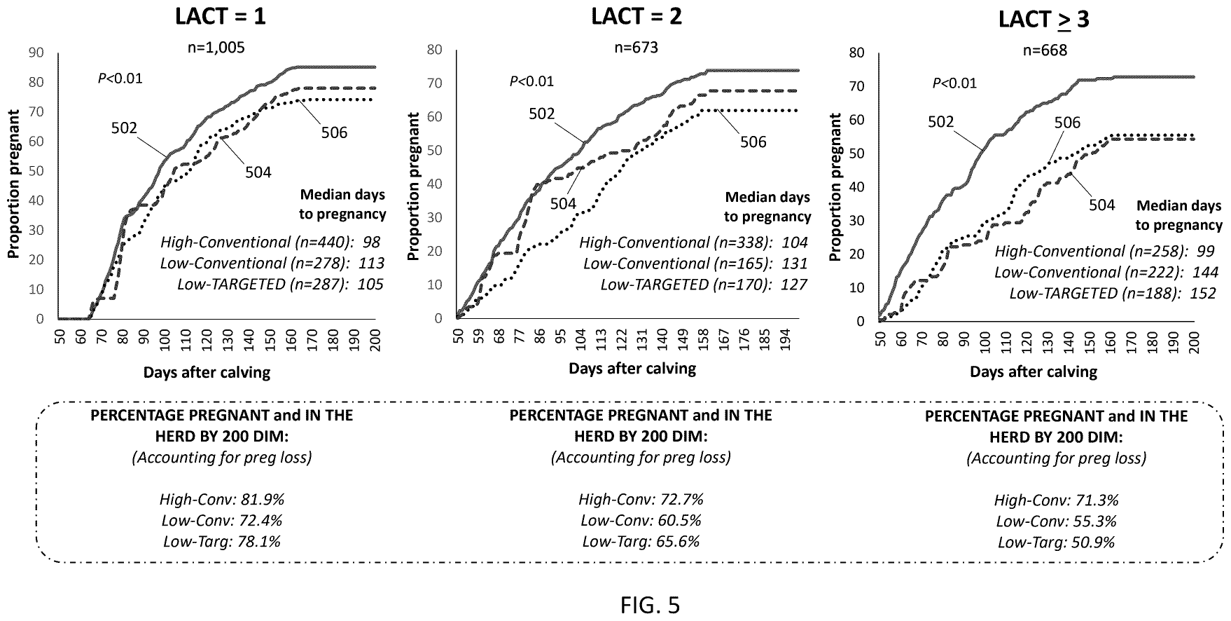

FIG. 5 illustrates three graphs, 5A to 5C, demonstrating the correlation between days to pregnancy and the percentage of dairy cows pregnant after calving, according to their lactation number, for each of said three groups. As shown in all three graphs, high fertility cows, represented by full line 502, became pregnant at a faster rate than low fertility cows, represented by broken lines 504 (fixed time artificial insemination) and 506 (insemination based on estrus detection). In addition, for lactation number 1 and 2 (graphs 5A and 5B), submission of low fertility dairy cows to a program focused on fixed time artificial insemination (line 504) resulted in cows becoming pregnant at a faster rate than the program focused on insemination based on estrus detection (line 506).

Accordingly, the results above provide proof of concept for the systems and methods described herein while also suggesting that, for dairy cows classified as low fertility, having a lactation number of 1 or 2, it is better to use “fixed time artificial insemination” rather than “insemination based on estrus detection”.

It is to be of note that though the above description relates specifically to rumination behavior, other types of behaviors exhibited by said given animal during said second period, such as grazing, eating, walking, and resting, to name a few, may also be relevant for fertility evaluation. In addition, it is to be of note that the system's capability to evaluate the level of fertility of said given animal may be derived, in conjunction with or instead of the above, from information that is not related to a specific behavior. In one non-limiting example, said information may involve a health index (e.g., a score between 0 and 100) derived from health information (e.g., activity-related information (e.g., daily activity, daily activity ratio, and the like), physiological information (e.g., temperature, heart rate, pH, and the like), behavioral information (e.g., grazing, eating, walking, resting, and the like), etc.) acquired by the given animal's monitoring device 106. In another non-limiting example, alternatively or additionally to the above, said information may involve a disease risk index (e.g., 0 to 100%) representing the given animal's likelihood of getting sick. Said disease risk index may be derived, for example, from information relating to: rumination, rumination peak, daily activity, daily activity ratio, daily health index, daily health index ratio, lactation number, etc., relating to a defined period post a calving event in said given animal (e.g., the first four days, though any other number of days may be applicable). In yet another non-limiting example, said information may involve a fertility index, representing the level of fertility of said given animal, generated, for example, by combining said disease risk, said health index, and information relating to heat events, as previously described.

By way of a non-limiting example, presented merely for the purpose of better understanding the presently disclosed subject matter and not intended in any way to limit its scope, in accordance with the above description relating to FIG. 1, to evaluate the fertility level of dairy cow 104, system 200 obtains the number of estrus events occurring in dairy cow 104 between day 25 and day 50 from its last calving event, and (ii) the daily rumination activity of dairy cow 104 between day one and day four from said last calving event. Based on the obtained number of estrus events and the daily rumination activity, system 200 evaluates the level of fertility of dairy cow 104 to be ‘high’.

It is to be noted, with reference to FIG. 3, that some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for evaluating a level of fertility of a given animal, the system comprising a processing circuitry configured to:
obtain: (i) information relating to estrus events occurring in said given animal during a first period following a calving event, and (ii) information relating to rumination behavior exhibited by said animal during a second period following said calving event; and,
based on said information relating to estrus events and said information relating to rumination behavior, evaluate the level of fertility of said given animal.

2. The system of claim 1, wherein said first period extends between day 1 and day 50, post calving.

3. The system of claim 1, wherein the duration of the first period varies depending on the given animal's number of lactations and the intensity of estrus.

4. The system of claim 1, wherein said second period extends between day 1 and day 15, post calving.

5. The system of claim 1, wherein said information relating to rumination behavior involves one or more of the following: (i) rumination activity per day, (ii) rumination activity ratio, and (iii) rumination peak.

6. The system of claim 1, wherein said information relating to estrus events may include one or more of: (i) a number of estrus events occurring in said given animal during said first period, and (ii) a level of intensity of one or more of said estrus events.

7. The system of claim 1, wherein based on the evaluation of the level of fertility, said system provides one or more suggestions on how to improve the animal's fertility.

8. The system of claim 7, wherein said suggestions involve providing a customized program of treatment based on the animal's properties.

9. The system of claim 1, wherein said system is configured to also obtain activity-related information exhibited by said animal following said calving event and evaluate the level of fertility of said animal based on said activity-related information along with said information relating to estrus events and said information relating to rumination behavior.

10. The system of claim 9, wherein said activity-related information includes one or more of: daily activity, and daily activity ratio.

11. A method for evaluating a level of fertility of a given animal comprising:
obtaining: (i) information relating to estrus events occurring in said given animal during a first period following a calving event, and (ii) information relating to rumination behavior exhibited by said animal during a second period following said calving event; and,
based on said information relating to estrus events and said information relating to rumination behavior, evaluating the level of fertility of said given animal.

12. The method of claim 11, wherein said first period extends between day 1 and day 50, post calving.

13. The method of claim 11, wherein the duration of the first period varies depending on the given animal's number of lactations and the intensity of estrus.

14. The method of claim 11, wherein said second period extends between day 1 and day 15, post calving.

15. The method of claim 11, wherein said information relating to rumination behavior involves one or more of the following: (i) rumination activity per day, (ii) rumination activity ratio, and (iii) rumination peak.

16. The method of claim 11, wherein said information relating to estrus events may include one or more of: (i) a number of estrus events occurring in said given animal during said first period, and (ii) a level of intensity of one or more of said estrus events.

17. The method of claim 11, wherein based on the evaluation of the level of fertility, said system provides one or more suggestions on how to improve the animal's fertility.

18. The method of claim 17, wherein said suggestions involve providing a customized program of treatment based on the animal's properties.

19. The method of claim 18, wherein said obtaining stage includes obtaining activity-related information exhibited by said animal following said calving event and evaluating the level of fertility of said animal based on said activity-related information along with said information relating to estrus events and said information relating to rumination behavior.

20. A non-transitory computer readable storage medium having computer readable program code embodied therewith, the computer readable program code, executable by at least one processor to perform a method for evaluating a level of fertility of a given animal, the method for evaluating a level of fertility of a given animal comprising:
obtaining: (i) information relating to estrus events occurring in said given animal during a first period following a calving event, and (ii) information relating to rumination behavior exhibited by said animal during a second period following said calving event; and,
based on said information relating to estrus events and said information relating to rumination behavior, evaluating the level of fertility of said given animal.
